(19) United States
(12) Patent Application Publication
(10) Pub. No.: US 2011/0231657 A1
(43) Pub. Date: Sep. 22, 2011

(54) APPARATUS AND METHOD FOR EMPLOYING CODES FOR TELECOMMUNICATIONS

(75) Inventors: Qingjiang Tian, San Diego, CA (US); Zhanfeng Jia, Belmont, CA (US); Lu Xiao, San Diego, CA (US); David Jonathan Julian, San Diego, CA (US)

(73) Assignee: QUALCOMM Incorporated, San Diego, CA (US)

(21) Appl. No.: 13/150,484

(22) Filed: Jun. 1, 2011

Related U.S. Application Data
(63) Continuation of application No. 12/405,097, filed on Mar. 16, 2009.

(51) Int. Cl. H04L 27/00; H03M 13/09; G06F 11/10; H04L 9/00

(52) U.S. Cl. 713/161; 714/807; 714/799; 375/295; 375/316; 714/E11.032

(57) ABSTRACT

A transmitting apparatus generates a first bit stream from a second bit stream by encoding at least a portion of the bits from the second bit stream, generates a code for the second bit stream, and attaches the code to the first bit stream for transmission to a receiving apparatus. A receiving apparatus receive from a transmitting apparatus a first bit stream with a code, generates a second bit stream from the first bit stream by decoding at least a portion of the bits from the first bit stream, computes the code for the second bit stream, and compares the computed code with the code from the first bit stream.

### CLAIM OF PRIORITY UNDER 35 U.S.C. §120

The present application for patent is a Continuation of patent application Ser. No. 12/405,097 entitled “APPARATUS AND METHOD FOR EMPLOYING CODES FOR TELECOMMUNICATIONS” filed Mar. 16, 2009, pending, and assigned to the assignee hereof and hereby expressly incorporated by reference herein.

### BACKGROUND

1. Field

The present disclosure relates generally to telecommunications, and more particularly, to an apparatus and method for employing codes for telecommunications.

2. Background

Data integrity codes have long been used in telecommunications to protect the integrity and/or authenticity of data transmitted across an unsecured medium. At the transmitter, a data integrity code is computed from an algorithm, which accepts as an input the data and a key. Ideally the key is known only to the transmitter and receiver engaged in secured communications. The data integrity code is then transmitted with the data to a receiver. At the receiver, the key is used to recompute the data integrity code from the data. The recomputed data integrity code is then compared to the code received with the data transmission. If the code recomputed by the receiver is identical to the code received with the transmission, then the receiver determines that the data is valid. Examples of data integrity codes include Message Integrity Code (MICs), Message Authentication Code (MACs), Message Authentication and Integrity Codes (MAICs), and the like.

While various techniques are commonly employed to protect the integrity and/or authenticity of data, other techniques are used to protect data from corruption due to noise and other disturbances in the transmission medium. Typically, these techniques take the form of error detection codes. Error detection codes differ from data integrity codes in that error detection codes are generally not well suited for protecting against the intentional alteration of data. Because error detection codes are unencrypted and generated without keys, the codes may be easily adjusted to match any changes made to the data.

Error detection codes are implemented by adding redundant information to the transmission. This redundancy may be used by the receiver to detect and, in some cases correct, errors in the transmission. A number of error detection codes are commonly used today in telecommunications, including by way of example, parity, checksum, and Cyclic Redundancy Check (CRC) codes. The error detection code is derived from the data by some algorithm and then transmitted with the data. The receiver applies the same algorithm to the data and compares the result to the received error detection code transmitted with the data. If a match occurs, the receiver determines that the data was successfully sent across the transmission medium.

The use of data integrity and error detection codes consumes valuable bandwidth. In wireless telecommunications, where bandwidth comes at a premium, the use of these codes can provide significant challenges to the designer, especially as more powerful codes are required to ensure the quality of transmission to the consumer of wireless services. Accordingly, there is a need in the art for improved methods for implementing data integrity and error detection codes while conserving bandwidth.

### SUMMARY

In one aspect of the disclosure, an apparatus for communications includes a processing system configured to generate a first bit stream from a second bit stream by encoding at least a portion of the bits from the second bit stream, the processing system being further configured to generate a code for the second bit stream and attach the code to the first bit stream for transmission to a remote apparatus.

In another aspect of the disclosure, an apparatus for communications includes a processing system configured to receive from a remote apparatus a first bit stream with a code, the processing system being further configured to generate a second bit stream from the first bit stream by decoding at least a portion of the bits from the first bit stream, and wherein the processing system is further configured to compute the code for the second bit stream and compare the computed code with the code from the first bit stream.

In yet another aspect of the disclosure, an apparatus for communications includes means for generating a first bit stream from a second bit stream by encoding at least a portion of the bits from the second bit stream, means for generating a code for the second bit stream, and means for attaching the code to the first bit stream for transmission to a remote apparatus.

In a further aspect of the disclosure, an apparatus for communications includes means for receiving from a remote apparatus a first bit stream with a code, means for generating a second bit stream from the first bit stream by decoding at least a portion of the bits from the first bit stream, and means for computing the code for the second bit stream and compare the computed code with the code from the first bit stream.

In yet a further aspect of the disclosure, method for communications includes generating a first bit stream from a second bit stream by encoding at least a portion of the bits from the second bit stream, generating a code for the second bit stream, and attaching the code to the first bit stream for transmission to a remote apparatus.

In another aspect of the disclosure, method for communications includes receiving from a remote apparatus a first bit stream with a code, generating a second bit stream from the first bit stream by decoding at least a portion of the bits from the first bit stream, and computing the code for the second bit stream and compare the computed code with the code from the first bit stream.

In yet another aspect of the disclosure, a computer-program product for communications includes computer-readable medium comprising codes executable by at least one processor to generate a first bit stream from a second bit stream by encoding at least a portion of the bits from the second bit stream, generate a code for the second bit stream, and attach the code to the first bit stream for transmission to a remote apparatus.

In yet a further aspect of the disclosure, a computer-program product for communications includes computer-readable medium comprising codes executable by at least one processor to receive from a remote apparatus a first bit stream with a code, generate a second bit stream from the first bit stream by decoding at least a portion of the bits from the first bit stream, and compute the code for the second bit stream and compare the computed code with the code from the first bit stream.

In yet a further aspect of the disclosure, a headset includes a processing system configured to generate a first bit stream from a second bit stream by encoding at least a portion of the bits from the second bit stream, the processing system being further configured to generate a code for the second bit stream and attach the code to the first bit stream for transmission to a remote apparatus, and a transducer configured to generate data contained in the second bit stream.

In yet a further aspect of the disclosure, a headset includes a processing system configured to receive from a remote apparatus a first bit stream with a code, the processing system being further configured to generate a second bit stream from the first bit stream by decoding at least a portion of the bits from the first bit stream, and wherein the processing system is further configured to compute the code for the second bit stream and compare the computed code with the code from the first bit stream, and a transducer configured to process data from the second bit stream.

In yet a further aspect of the disclosure, a watch includes a processing system configured to generate a first bit stream from a second bit stream by encoding at least a portion of the bits from the second bit stream, the processing system being further configured to generate a code for the second bit stream and attach the code to the first bit stream for transmission to a remote apparatus, and a user interface configured to generate data contained in the second bit stream.

In yet a further aspect of the disclosure, a watch includes a processing system configured to receive from a remote apparatus a first bit stream with a code, the processing system being further configured to generate a second bit stream from the first bit stream by decoding at least a portion of the bits from the first bit stream, and wherein the processing system is further configured to compute the code for the second bit stream and compare the computed code with the code from the first bit stream, and a user interface configured to process data from the second bit stream.

In yet a further aspect of the disclosure, a sensing device includes a processing system configured to generate a first bit stream from a second bit stream by encoding at least a portion of the bits from the second bit stream, the processing system being further configured to generate a code for the second bit stream and attach the code to the first bit stream for transmission to a remote apparatus, and a sensor configured to generate data contained in the second bit stream.

In yet a further aspect of the disclosure, a sensing device includes a processing system configured to receive from a remote apparatus a first bit stream with a code, the processing system being further configured to generate a second bit stream from the first bit stream by decoding at least a portion of the bits from the first bit stream, and wherein the processing system is further configured to compute the code for the second bit stream and compare the computed code with the code from the first bit stream, and a sensor configured to process data from the second bit stream.

It is understood that other aspects of the disclosure will become readily apparent to those skilled in the art from the following detailed description, wherein various aspects of the invention are shown and described by way of illustration. As will be realized, these aspects of the disclosure may be implemented in other and different configurations and its several details are capable of modification in various other respects. Accordingly, the drawings and detailed description are to be regarded as illustrative in nature and not as restrictive.

### BRIEF DESCRIPTION OF THE DRAWINGS

FIG. 1 is a conceptual diagram illustrating an example of a wireless network;

FIG. 2 is a conceptual diagram illustrating an example of a first apparatus in communication with a second apparatus in a wireless network;

FIG. 3 is a conceptual diagram illustrating an example of a data packet structure used by the apparatus in a wireless network;

FIG. 4 is a conceptual diagram illustrating an example of the functionality of a transmitting and receiving apparatus.

In accordance with common practice, some of the drawings may be simplified for clarity. Thus, the drawings may not depict all of the components of a given apparatus or method.

### DETAILED DESCRIPTION

Various aspects of the invention are described more fully hereinafter with reference to the accompanying drawings. This invention may, however, be embodied in many different forms and should not be construed as limited to any specific structure or function presented in this disclosure. Rather, these aspects are provided so that this disclosure will be thorough and complete, and will fully convey the scope of the invention to those skilled in the art. As those skilled in the art will readily appreciate, the scope of the invention is intended to cover any aspect of the invention disclosed herein, whether implemented independently of or combined with other aspects of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect of the invention disclosed herein may be embodied by one or more elements of a claim.

Several aspects of the invention are directed to techniques for using codes to support telecommunications. As used herein, the term “code” refers to any sequence of symbols, bits, chips, or other elements that are transmitted with data to enhance reliability. By way of example, the term “code” may be used to refer to a data integrity code which protects the integrity and/authenticity of the data. Examples of data integrity codes include MICs, MACs, and MAICs. Alternatively, the term “code” may be used to refer to an error detection code which provides an indication as to whether the data has been corrupted by the transmission medium. Examples of error detection codes include parity, checksum, CRC, and the like.

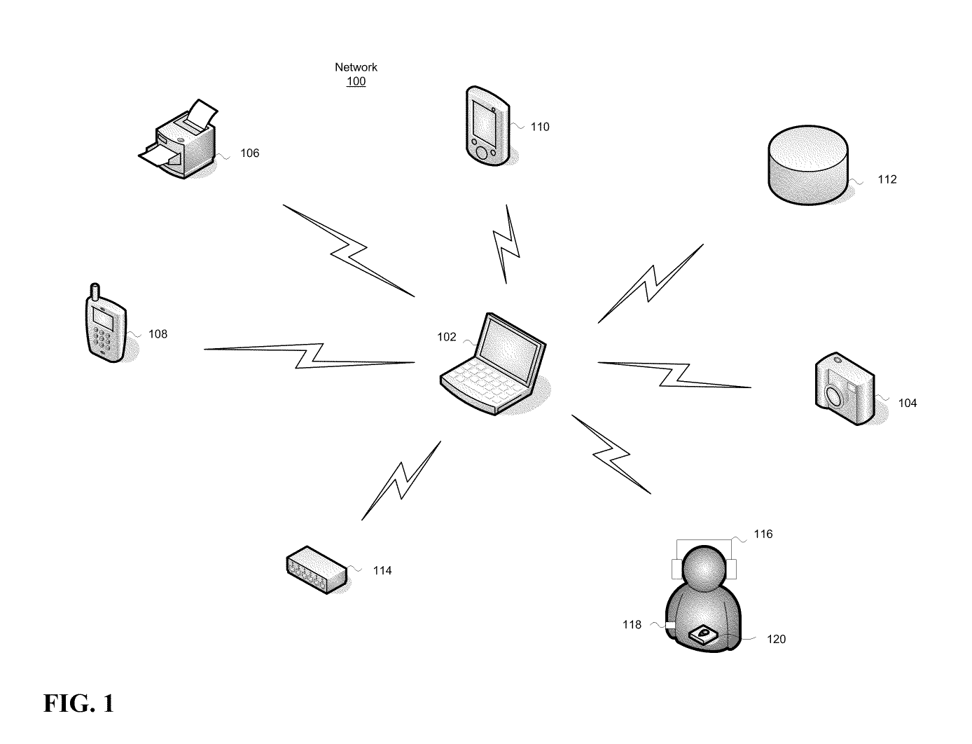

An apparatus incorporating any aspect of the invention may be a wireless node capable of operating in the short range communications network shown in FIG. 1. The network 100 may be configured to support using any suitable radio technology or wireless protocol. By way of example, the network 100 may be configured to support Ultra-Wideband (UWB) technology. UWB is a common technology for high speed short range communications and is defined as any radio technology having a spectrum that occupies a bandwidth greater than 20 percent of the center frequency, or a bandwidth of at least 500 MHz. Alternatively, the network 100 may be configured to support various wireless protocols such as Bluetooth or IEEE 802.11, just to name a few.

The network 100 is made up of various wireless nodes including a computer 102. In this example, the computer 102 may receive digital photos from a digital camera 104, send documents to a printer 106 for printing, synch-up with e-mail on a personal digital assistant (PDA) 108, transfer music files to a digital audio player (e.g., MP3 player) 110, back up data and files to a mobile storage device 112, and communicate with a remote network (e.g., the Internet) via a wireless hub 114. The network 100 may also include a number of mobile and compact nodes, either wearable or implanted into the human body. By way of example, a person may be wearing a headset 116 (e.g., headphones) that transmits audio from a transducer to the computer 102, a watch 118 that transmits time or other information from a user interface to the computer 102, and/or a sensor 120 which monitors vital body parameters (e.g., a biometric sensor, a heart rate monitor, a pedometer, and EKG device, etc.). The sensor 120 transmits information from the body of the person to the computer 102 where the information may be forwarded to a medical facility (e.g., hospital, clinic, etc) via the wireless hub 114.

Although well suited for a short range communications network, an apparatus incorporating any aspect of the invention may be extended to other applications. By way of example, the apparatus may be a wireless node operating a wide area network supporting any suitable wireless protocol, such as Evolution-Data Optimized (EV-DO), Ultra Mobile Broadband (UMB), Code Division Multiple Access (CDMA) 2000, Long Term Evolution (LTE), Wideband CDMA (W-CDMA), or the like. Alternatively, the apparatus may be a wired node configured to support wired communications using cable modem, Digital Subscriber Line (DSL), fiber optics, Ethernet, HomeRF, or any other suitable wired access protocol.

As will be readily apparent from above, an apparatus incorporating any aspect of the invention may be any suitable telecommunications device. Alternatively, the apparatus may be any part of a telecommunications device, such as one or more integrated circuits, either alone or mounted onto a printed circuit board or other suitable substrate. The apparatus may also be one or more substrates, with each substrate having one or more integrated circuits and/or discrete electrical components. As those skilled in the art will readily recognize, the various aspects of the invention may be embodied in various forms that provide the functionality presented throughout this disclosure.

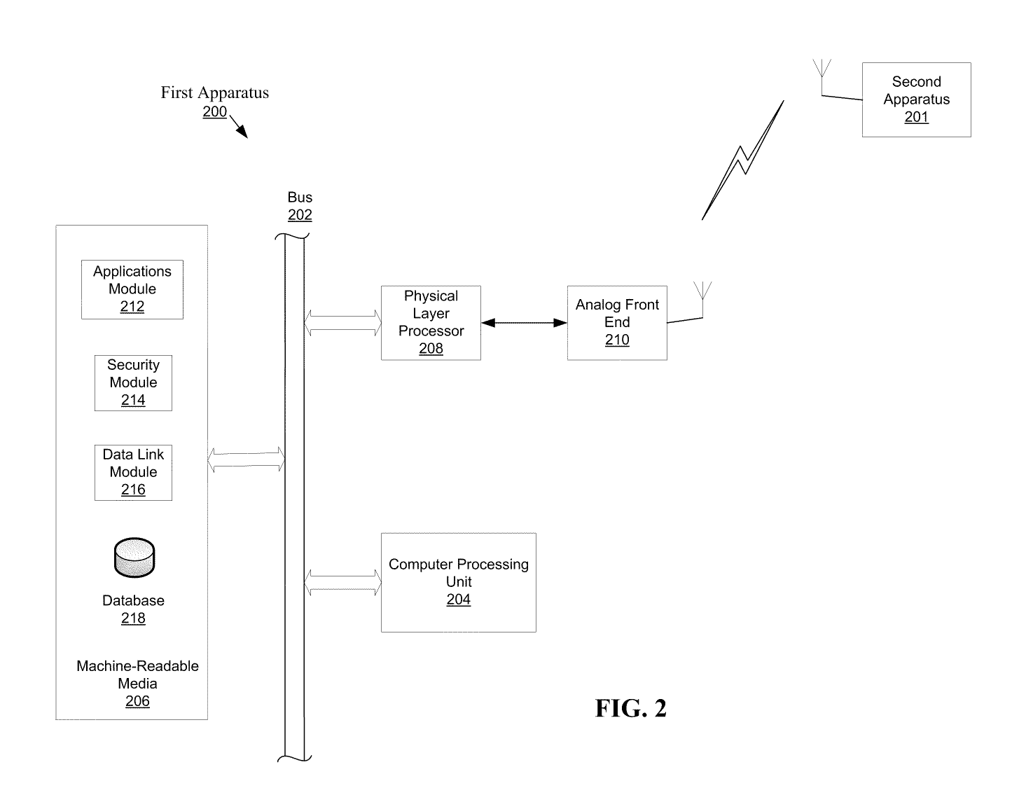

Several aspects of an apparatus and method for telecommunications will now be presented with reference to FIG. 2. The apparatus will be described as a transceiver, which means it can perform both a transmitting and receiving function. However, as those skilled in the art will readily appreciate, various aspects of the invention may be incorporated in an apparatus that provides only a transmitting or receiving function.

FIG. 2 is a conceptual diagram illustrating an example of a first apparatus 200 in communication with a second apparatus 201. In this example, the first apparatus 200 includes a bus 202 that links together various circuits including a central processing unit (CPU) 204, machine-readable media 206, and a physical layer processor 208. The bus 202 may also link various other circuits such as timing sources, peripherals, voltage regulators, power management circuits, and the like, which are well known in the art, and therefore, will not be described any further. An analog front end (AFE) 210 may be used to interface the first apparatus 200 to the transmission medium. Although not shown, the second apparatus 201 may have a similar configuration.

The CPU 204 is responsible for managing the bus and general processing, including the execution of software stored on the machine-readable media 206. The machine-readable media 206 is shown with a number of software modules and a database 218. Each module includes a set of instructions that when executed by the CPU 204 cause the CPU 204 to perform the various functions described below. The software modules include an applications module 212, a security module 214, and a data link module 216. When referring to the functionality of any module, it will be understood that such functionality is performed by the CPU 204 retrieving and executing instructions within the module.

The physical layer processor 208 and the AFE 210 implement the physical layer by providing the means to transmit and receive data in accordance with the physical and electrical specifications required to interface to the transmission medium. By way of example, the physical layer processor 208, when operating in the transmit mode, may retrieve data packets from the database 218 and provide various signal processing functions such as convolution encoding, interleaving, and signal constellation mapping. The data packets may then be provided to the AFE 210 to modulate a carrier signal for transmission. When operating in the receive mode, the physical layer processor 208 demaps, deinterleaves, and decodes the data packets recovered by the AFE 210 from the carrier signal and provides the data packets to the database 218.

The data link module 216 provides the means for transferring data packets between the first and second apparatuses 200 and 201 by establishing and maintaining a communications channel over the physical layer. The data link module 216 may be used by the first apparatus 200 to establish a communications channel with the second apparatus 201 through various handshaking and training procedures. As part of this process, the data link module 216 facilitates the exchange of addresses between the first and second apparatuses 200 and 201. In addition, the data link module 216 assigns and transmits a remote identifier (RemoteID) to the second apparatus 201 and receives a RemoteID assigned and transmitted by the second apparatus 201. The data link module 216 maps the RemoteID received from the second apparatus 201 to the address for the second apparatus 201 and provides the mapping to the database 218.

Once a communications channel is established between the first and second apparatuses 200 and 201, various data processing functions may be performed by the applications module 212. By way of example, the applications module 212 may include various codecs to support audio, video, and/or other multimedia applications. Alternatively, or in addition to, the applications module 212 include a graphics processor for rendering graphics. The data processing functions may be performed on data generated by a user interface (not shown) and/or retrieved from the database 218. The processed data may then be written to the database 218 and/or presented to the user interface (not shown).

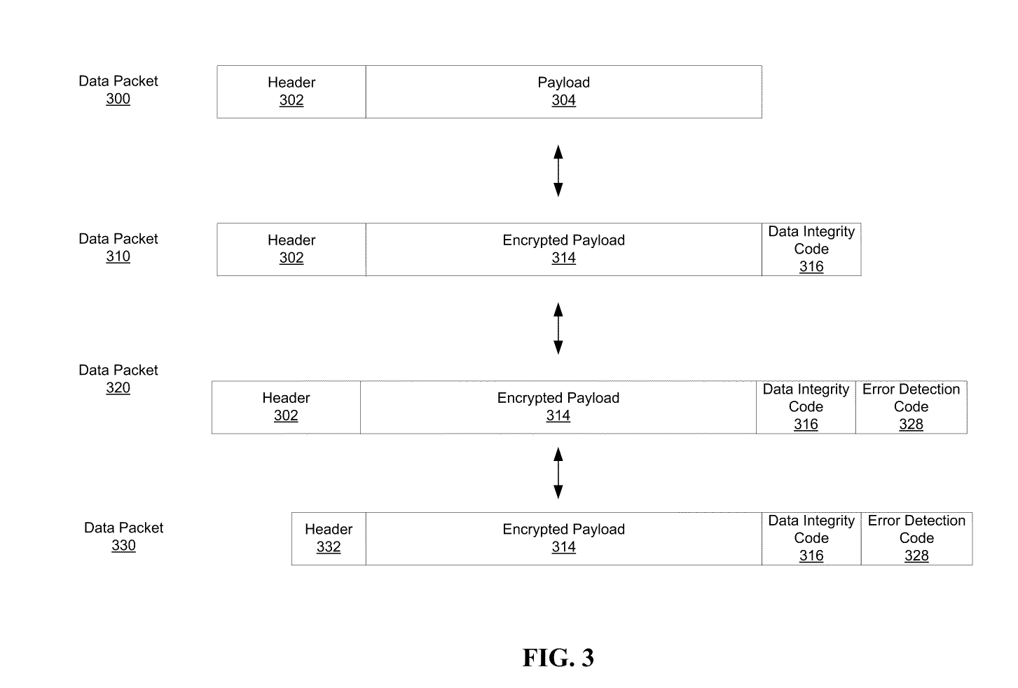

The data link module 216 is also responsible for generating and maintaining the data packet structure for transmitting and receiving data. FIG. 3 is a conceptual diagram illustrating an example of a data packet structure used by the apparatus in a wireless network. The data packet 300 includes a header 302 and a payload 304. In the transmit mode, the payload 304 contains data from the user interface and/or database, and in the receive mode, the payload 304 contains data to be written to the database and/or presented to the user interface. The header may contain various information that makes it possible for multiple apparatuses to share access to the transmission medium.

The transmitting function of the first apparatus will now be described with reference to FIGS. 2 and 3. The data link module 216 creates a series of data packets for transmission to the second apparatus 201. Each data packet 300 includes the header 302 having the source address for the first apparatus 200 along with other information and the payload 304 containing a data from the database 218.

The security module 214 may be used to provide security over the communications channel. The security module 214 implements an algorithm, which accepts as an input a first key and a data packet 300 to generate a data integrity code. The data integrity code may then be used to protect the integrity and/or authenticity of the data packet, regardless of whether or not the payload is encrypted.

In the case of an encrypted payload, the data packet 300 is processed by encrypting the payload with a second key and appending the data integrity code to the encrypted payload, as shown by data packet 310 which includes the header 302, the encrypted payload 314, and the data integrity code 316. The data integrity code protects the integrity of the data packet, as well as its authenticity, by enabling the second apparatus 201, who also possesses the keys, to decrypt the payload and detect any changes to the data packet. Alternatively, the data integrity code may be computed over encrypted payload. By doing so, the recipient verifies data integrity code first. If it fails, the data packet may be discarded and payload decryption is not necessary.

The first and second keys may be the same key or different keys. The keys may be exchanged when the communications channel is being established, or generated from signaling during the establishment of the channel, or provisioned, or generated by some other suitable means.

The data link module 216 is also responsible for generating error detection codes that may be used by the second apparatus 201 to detect errors in the physical layer. The error detection code may be a parity code, checksum, a CRC code, or some other suitable error detection code. For each data packet, the data link module 216 computes an error detection code by applying an algorithm to the data packet 310. The computed error detection code may then be appended to the data integrity code, as shown by data packet 320 which includes the header 302, the encrypted payload 314, the data integrity code 316, and the error detection code 328.

Before providing the data packet to the physical layer processor 208 and the AFE 210, the data link module 216 may replace the source address in the header with the RemoteID assigned to the first apparatus 200 by the second apparatus 201 during channel set-up. The RemoteID, which uniquely identifies the first apparatus 200 as the source of the data packet among all nodes that send packets to the second apparatus 201, may be retrieved from the database 218. By sending the RemoteID in place of the source address, considerable bandwidth may be saved. By way of example, it is not uncommon for an apparatus or node to have a 64-bit address. The RemoteID can be reduced to an 8-bit number for a network in which each apparatus or node is required to support a maximum of 256 communication channels. An example of a data packet after this operation is shown in FIG. 3. The data packet 330 has a header 332 with reduced information, the encrypted payload 314, the data integrity code 316, and the error detection code 328.

In addition to providing a transmitting function, the first apparatus 200 may also be capable of providing a receiving function. The receiving function will now be described with reference to FIGS. 2 and 3. In this example, the AFE 210 and physical layer processor 208 receives a transmission from the second apparatus 201 and processes the transmission in the same manner described earlier. That is, the physical layer processor 208 demaps, deinterleaves, and decodes the data packets recovered by the AFE 210 from the carrier signal and provides the data packets to the database 218. The data packets 330 are then written by the physical layer processor 208 to the database 218.

For each received data packet, the data link module 216 searches the database 218 for a source address corresponding to the RemoteID in the header 332. In this example, the data link module 216 determines that the transmission is from the second apparatus 201 and replaces the RemoteID in the header with the source address for the second apparatus 201, as shown by data packet 320. Once the RemoteID in the header is replaced with the source address, the data link module 216 computes an error detection code from the header 302, encrypted payload 314, and data integrity code 316 contained in the data packet 320. The computed error protection code is then compared to the error detection code 328 in the data packet 320. If the computed error detection code matches, the data link module 216 determines that the data packet was successfully decoded by the physical layer. If the computed error detection code does not match, the data packet is deemed to be corrupted. In that event, the data link module 216 may discard the data packet, and depending on the particular application, may request a retransmission of the data packet from the second apparatus 201.

For each successfully decoded data packet 310, the security module 214 will decrypt the payload with the second key, as shown by data packet 300 which contains the header 302 and the payload 304. Using the first key, the security module 214 then computes a data integrity code from the data packet 300. The computed data integrity code is then compared to the integrity protection code 316 in the received data packet 310. If the computed data integrity matches, the security module 214 determines that the integrity of the data packet has been maintained and authenticates the second apparatus as the source of the data packet. If the computed data integrity code does not match, the security module 214 is unable to authenticate the source of the data packet and/or verify the integrity of the data packet. Once the data packet 300 is authenticated, and the integrity of the data packet 300 is verified, the payload 304 may be used by the applications module 212 for further data processing.

The apparatus 200 may be implemented as hardware, software, or combinations of both. To illustrate this interchangeability of hardware and software, the apparatus has been described above generally in terms of its functionality. Whether such functionality is implemented as hardware or software depends upon the particular application and design constraints imposed on the overall system. Skilled artisans may implement the described functionality in varying ways for each particular application.

Various aspects of an apparatus presented throughout this disclosure may be implemented with a processing system. The processing system may be implemented with a digital signal processor (DSP) in an application specific circuit (ASIC). Machine-readable media may be used to store software that implements various functions described throughout this disclosure when executed by the DSP. The machine-readable media, either in whole or part, may be integrated into or external to the ASIC. As another example, the processing system may be implemented with a microprocessor capable of accessing software stored on external machine-readable media. The software may implement various functions described herein when executed by the microprocessor. Other software implementations of the processing system on different hardware platforms will become readily apparent to those skilled in the art. Hardware implementations of the processing system may include gated logic, discrete hardware components, or other dedicated hardware capable of performing various functions described throughout this disclosure.

Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof.

The software supported by the machine-readable media may reside in a single storage device or distributed across multiple memory devices. By way of example, software may be loaded into RAM from a hard drive. During execution of the software, some of the instructions may be loaded from RAM to cache to increase access speed. One or more cache lines may then be loaded into a general register file for execution. When referring to the functionality of a software, it will be understood that such functionality is implemented by a hardware platform executing software instructions.

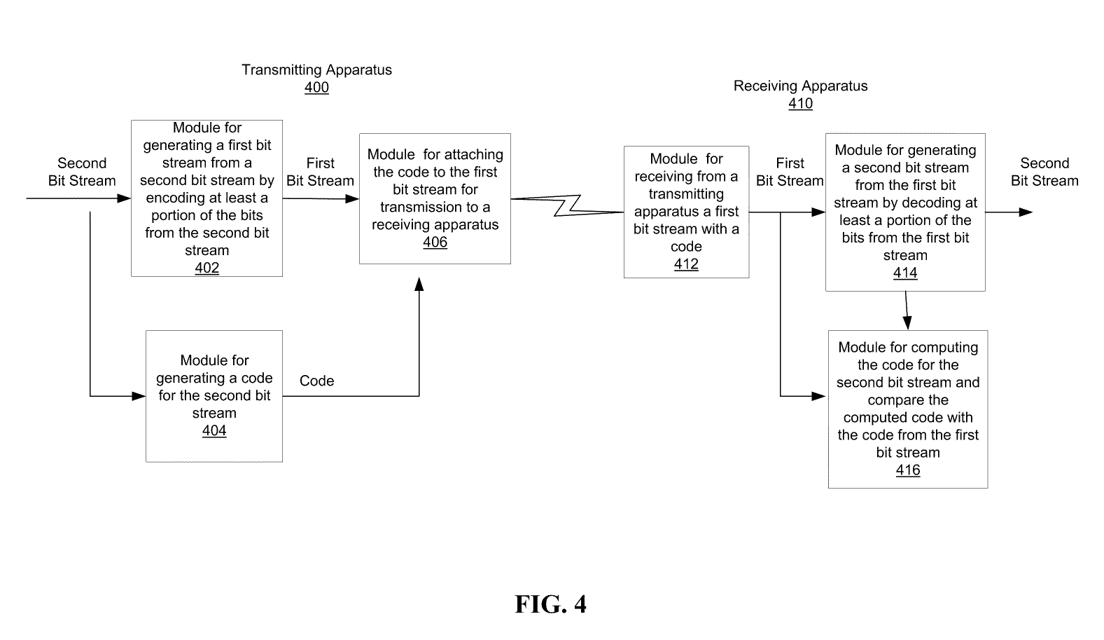

FIG. 4 is a conceptual diagram illustrating an example of the functionality of a transmitting and receiving apparatus implementing codes for telecommunications. A transmitting apparatus 400 includes a module 402 for generating a first bit stream from a second bit stream by encoding at least a portion of the bits from the second bit stream, a module 404 for generating a code for the second bit stream, and a module 406 for attaching the code to the first bit stream for transmission to a receiving apparatus. A receiving apparatus 410 includes a module 412 for receiving from a transmitting apparatus a first bit stream with a code, a module 414 for generating a second bit stream from the first bit stream by decoding at least a portion of the bits from the first bit stream, and a module 416 for computing the code for the second bit stream and compare the computed code with the code from the first bit stream.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for communications, comprising:
a processing system configured to generate a first bit stream from a second bit stream by encoding at least a portion of the bits from the second bit stream, the processing system being further configured to generate a code for the second bit stream and attach the code to the first bit stream for transmission to a remote apparatus.

2. The apparatus of claim 1, wherein the second bit stream comprises a header, and wherein the processing system is further configured to encode the at least portion of the bits from the header of the second bit stream.

3. The apparatus of claim 1, wherein encoding the at least portion of the bits of the second bit stream comprises encrypting the at least portion of the bits of the second bit stream.

4. The apparatus of claim 1, wherein the code comprises an error detection code.

5. The apparatus of claim 4, wherein the error detection code comprises a cyclic redundancy check.

6. The apparatus of claim 1, wherein the code comprises a data integrity code.

7. The apparatus of claim 6, wherein the processing system is further configured to encrypt a payload, and wherein the second bit stream comprises a header and the encrypted payload, the processing system being further configured to generate the data integrity code from the header and the encrypted payload.

8. The apparatus of claim 6, wherein the processing system is further configured to generate the data integrity code by using a key.

9. The apparatus of claim 8, wherein encoding the at least portion of the bits of the second bit stream comprises encrypting the at least portion of the bits of the second bit stream using the key.

10. The apparatus of claim 6, wherein the processing system is further configured to generate an error detection code for the second bit stream and append the error detection code to the data integrity code.

11. An apparatus for communications, comprising:
a processing system configured to receive from a remote apparatus a first bit stream with a first code, the processing system being further configured to generate a second bit stream from the first bit stream by decoding at least a portion of the bits from the first bit stream, wherein the processing system is further configured to compute a second code for the second bit stream and compare the second code with the first code from the first bit stream.

12. The apparatus of claim 11, wherein the first bit stream comprises a header, and wherein the processing system is further configured to decode the at least portion of the bits from the header of the first bit stream.

13. The apparatus of claim 11, wherein decoding the at least portion of the bits of the first bit stream comprises decrypting the at least portion of the bits of the first bit stream.

14. The apparatus of claim 11, wherein the first code comprises an error detection code.

15. The apparatus of claim 14, wherein the error detection code comprises a cyclic redundancy check.

16. The apparatus of claim 11, wherein the second code comprises a data integrity code.

17. The apparatus of claim 16, wherein the processing system is further configured to compute the data integrity code by using a key.

18. The apparatus of claim 17, wherein decoding the at least portion of the bits of the first bit stream comprises decrypting the at least portion of the bits of the first bit stream using the key.

19. An apparatus for communications, comprising:
means for generating a first bit stream from a second bit stream by encoding at least a portion of the bits from the second bit stream;
means for generating a code for the second bit stream; and
means for attaching the code to the first bit stream for transmission to a remote apparatus.

20. An apparatus for communications, comprising:
means for receiving from a remote apparatus a first bit stream with a first code;
means for generating a second bit stream from the first bit stream by decoding at least a portion of the bits from the first bit stream; and
means for computing a second code for the second bit stream and compare the second code with the first code from the first bit stream.

21. A method for communications, comprising:
generating a first bit stream from a second bit stream by encoding at least a portion of the bits from the second bit stream;
generating a code for the second bit stream; and
attaching the code to the first bit stream for transmission to a remote apparatus.

22. The method of claim 21, wherein the second bit stream comprises a header, and wherein the first bit stream is generated by encoding the at least portion of the bits from the header of the second bit stream.

23. The method of claim 21, wherein encoding the at least portion of the bits of the second bit stream comprises encrypting the at least portion of the bits of the second bit stream.

24. The method of claim 21, wherein the code comprises an error detection code.

25. The method of claim 24, wherein the error detection code comprises a cyclic redundancy check.

26. The method of claim 21, wherein the code comprises a data integrity code.

27. The method of claim 26, further comprising encrypting a payload, and wherein the second bit stream comprises a header and the encrypted payload, and wherein the data integrity code is generated from the header and the encrypted payload.

28. The method of claim 26, wherein the data integrity code is generated by using a key.

29. The method of claim 28, wherein encoding the at least portion of the bits of the second bit stream comprises encrypting the at least portion of the bits of the second bit stream using the key.

30. The method of claim 26, further comprising generating an error detection code for the second bit stream and appending the error detection code to the data integrity code.

31. A method for communications, comprising:
receiving from a remote apparatus a first bit stream with a first code;
generating a second bit stream from the first bit stream by decoding at least a portion of the bits from the first bit stream;
computing a second code for the second bit stream and comparing the second code with the first code from the first bit stream.

32. The method of claim 31, wherein the first bit stream comprises a header, and wherein the first bit stream is generated by decoding the at least portion of the bits from the header of the first bit stream.

33. The method of claim 31, wherein decoding the at least portion of the bits of the first bit stream comprises decrypting the at least portion of the bits of the first bit stream.

34. The method of claim 31, wherein the first code comprises an error detection code.

35. The method of claim 34, wherein the error detection code comprises a cyclic redundancy check.

36. The method of claim 31, wherein the second code comprises a data integrity code.

37. The method of claim 36, wherein the data integrity code is computed by using a key.

38. The method of claim 37, wherein decoding the at least portion of the bits of the first bit stream comprises decrypting the at least portion of the bits of the first bit stream using the key.

39. A computer-program product for communications, comprising:
a computer-readable storage medium encoded with codes executable to:
generate a first bit stream from a second bit stream by encoding at least a portion of the bits from the second bit stream;
generate a code for the second bit stream; and
attach the code to the first bit stream for transmission to a remote apparatus.

40. A computer-program product for communications, comprising:
a computer-readable storage medium encoded with codes executable to:
receive from a remote apparatus a first bit stream with a first code;
generate a second bit stream from the first bit stream by decoding at least a portion of the bits from the first bit stream; and
compute a second code for the second bit stream and compare the second code with the first code from the first bit stream.

41. A headset, comprising:
a processing system configured to generate a first bit stream from a second bit stream by encoding at least a portion of the bits from the second bit stream, the processing system being further configured to generate a code for the second bit stream and attach the code to the first bit stream for transmission to a remote apparatus; and
a transducer configured to generate data contained in the second bit stream.

42. A headset, comprising:
a processing system configured to receive from a remote apparatus a first bit stream with a first code, the processing system being further configured to generate a second bit stream from the first bit stream by decoding at least a portion of the bits from the first bit stream, wherein the processing system is further configured to compute a second code for the second bit stream and compare the second code with the first code from the first bit stream; and
a transducer configured to process data from the second bit stream.

43. A watch, comprising:
a processing system configured to generate a first bit stream from a second bit stream by encoding at least a portion of the bits from the second bit stream, the processing system being further configured to generate a code for the second bit stream and attach the code to the first bit stream for transmission to a remote apparatus; and
a user interface configured to generate data contained in the second bit stream.

44. A watch, comprising:
a processing system configured to receive from a remote apparatus a first bit stream with a first code, the processing system being further configured to generate a second bit stream from the first bit stream by decoding at least a portion of the bits from the first bit stream, wherein the processing system is further configured to compute a second code for the second bit stream and compare the second code with the first code from the first bit stream; and
a user interface configured to process data from the second bit stream.

45. A sensing device, comprising:
a processing system configured to generate a first bit stream from a second bit stream by encoding at least a portion of the bits from the second bit stream, the processing system being further configured to generate a code for the second bit stream and attach the code to the first bit stream for transmission to a remote apparatus; and
a sensor configured to generate data contained in the second bit stream.

46. A sensing device, comprising:
a processing system configured to receive from a remote apparatus a first bit stream with a first code, the processing system being further configured to generate a second bit stream from the first bit stream by decoding at least a portion of the bits from the first bit stream, wherein the processing system is further configured to compute a second code for the second bit stream and compare the second code with the first code from the first bit stream; and
a sensor configured to process data from the second bit stream.
